(19) United States
(12) Patent Application Publication
(10) Pub. No.: US 2013/0142981 A1
(43) Pub. Date: Jun. 6, 2013

(54) SCREEN PROTECTOR

(71) Applicant: KUO-CHENG HUANG, NEW TAIPEI CITY (TW)

(72) Inventor: KUO-CHENG HUANG, NEW TAIPEI CITY (TW)

(73) Assignee: CHIA-CHUN HUNG, NEW TAIPEI CITY (TW)

(21) Appl. No.: 13/452,946

(22) Filed: Apr. 23, 2012

(30) Foreign Application Priority Data
Dec. 6, 2011 (TW) 100222994

(51) Int. Cl. B32B 3/10

(52) U.S. Cl. 428/41.8; 428/201

(57) ABSTRACT

A screen protector includes a protective film layer, an ink layer disposed circularly around full edges of the protective film layer, and a printed adhesive layer formed on top of the ink layer, and the printed adhesive layer is manufactured by a printing process to lower the manufacturing cost effectively.

### CROSS-REFERENCE TO RELATED APPLICATIONS

This non-provisional application claims priority under 35 U.S.C. §119(a) on Patent Application No(s). 100222994 filed in Taiwan, R.O.C. on Dec. 6, 2011, the entire contents of which are hereby incorporated by reference.

### BACKGROUND OF THE INVENTION

1. Field of the Invention

The present invention relates to a screen protector, in particular to the screen protector having an adhesive layer manufactured by a printing process.

2. Description of the Related Art

Electronic products are popular. For example, mobile phones, computers, televisions, notebook computers, and flat PCs have become necessary items of our life, and screen protectors used for protecting a screen surface of these electronic products become increasingly important, particularly for the touch panels that are touched by external forces frequently. Therefore, these products rely on an external protective film to extend their service life.

In the present existing protective films, a scratch resisting plastic material such as PET (Polyethylene Terephthalate) is generally used as a substrate and a plastic material is attached onto the scratch resisting plastic material in order to fix the protective film on top of a panel, and screen protector manufacturers generally manufacture the substrate and then cut purchased double-sided adhesive tape into appropriate width and size, and finally attached the double-sided adhesive tape onto the substrate by a pressing or hot welding method manually or through a machine. The screen protector manufactured by the aforementioned method not only incurs a high manufacturing cost, but also requires a complicated manufacturing process, and has a risk of ungluing the adhesive tape, since the adhesive force relies on the properties of the glue.

In view of the aforementioned problem of the prior art, the inventor of the present invention based on years of experience in the protective film related industry to conduct researches and experiments, and finally developed a novel screen protector that applies glues by a printing process to lower the cost and prevent the glues from becoming unglued.

### SUMMARY OF THE INVENTION

Therefore, it is a primary objective of the present invention to provide an improved screen protector having an adhesive layer manufactured by a printing process.

To achieve the foregoing objective, the present invention provides a screen protector comprising: a protective film layer; an ink layer, circularly disposed around all edges of the protective film layer; and a printed adhesive layer, disposed on top of the ink layer; wherein, the printed adhesive layer is set by a printing process. Wherein, the protective film layer is a film made of a composite material selected from the collection of PET (Polyethylene Terephthalate), PC (Polycarbonate), PP (Polypropylene), and PMMA (Polymethyl Methacrylate), and the protective film layer has a thickness falling within a range from 0.05 mm to 0.5 mm and a light transmittance falling within a range from 90% to 96%. Wherein, the printed adhesive layer includes 70% to 85% of silicone or and hardening material. The printed adhesive layer has an openwork pattern and a border pattern. To protect the surface from being damaged by external forces, the screen protector further comprises a releasing layer a covered onto the protective film layer and the printed adhesive layer and a protective layer covered onto the other side of the protective film layer. To achieve the effect of emitting light at nights, the ink layer includes a luminous pigment.

In a preferred embodiment, the screen protector further comprises a coating layer disposed between the protective film layer and the ink layer.

With the aforementioned design, the present invention can overcome the drawbacks of the prior art, not only reducing the cost and simplifying the manufacturing process, but also reducing the chance of having a ungluing problem.

### BRIEF DESCRIPTION OF THE DRAWINGS

FIG. 1 is a front view of a preferred embodiment of the present invention;

FIG. 2 is a cross-sectional view of a preferred embodiment of the present invention; and

FIG. 3 is a cross-sectional view of another preferred embodiment of the present invention.

### DETAILED DESCRIPTION OF THE PREFERRED EMBODIMENTS

The technical contents of the present invention will become apparent with the detailed description of preferred embodiments and the illustration of related drawings as follows.

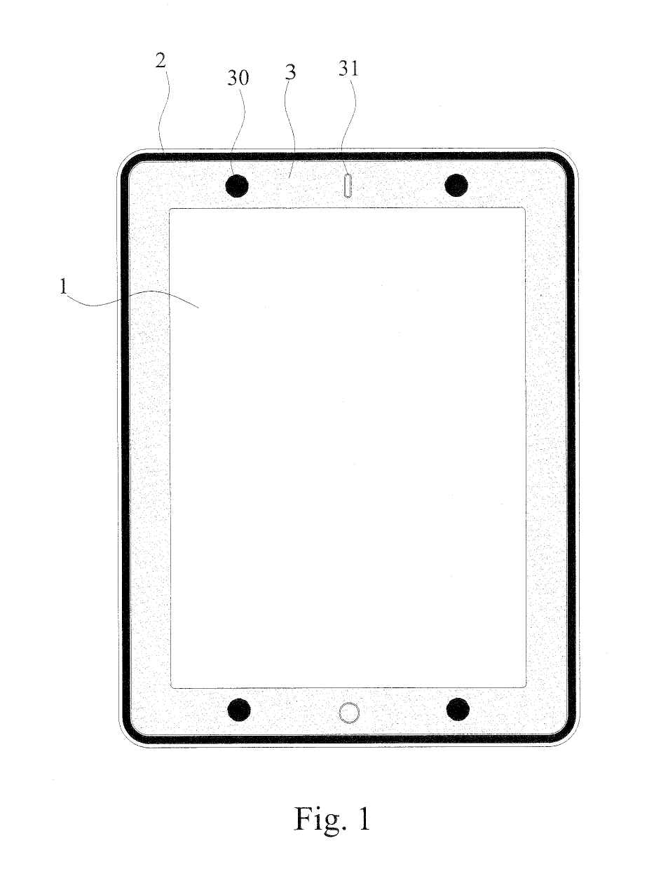

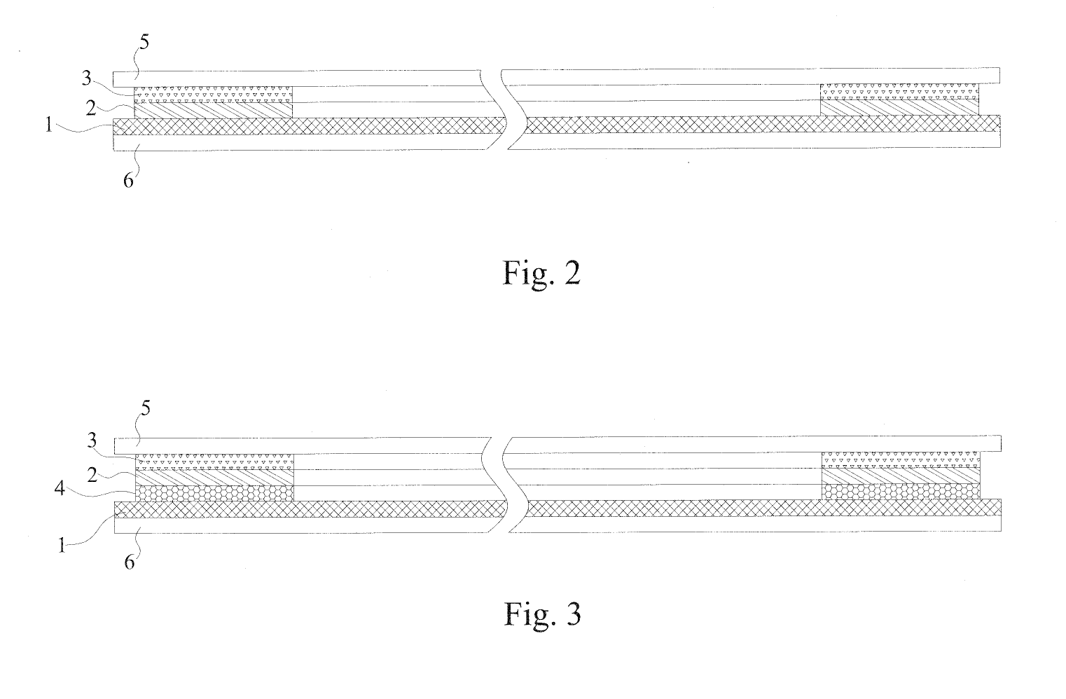

With reference to FIGS. 1 and 2 for a front view and a cross-sectional view of a preferred embodiment of the present invention respectively, the screen protector comprises a protective film layer 1, which is the substrate of the screen protector and made of a composite material such as, PET, PC, PP or PMMA and processed by a double-sides atomization AG (Anti-Glare) process, or AFP(Anti-Fingerprint) process or AR (Anti-Reflection) process. The protective film layer 1 has a thickness of 0.05 mm-0.5 mm and a light transmittance of 90%˜96%. The protective film layer 1 has an ink layer 2 made of a colored (black or white) light shading material and formed on full edges of the protective film layer 1, or printed with a luminous pigment, and the ink layer 2 is circularly disposed around all edges of the protective film layer 1, and a printed silicone glue layer 3 disposed on top of the ink layer 2 is attached onto the top of the ink layer 2 by an electric flat screen printing machine, wherein the printed silicone glue layer 3 is made of 70%˜85% of silicone and hardening material. The printed adhesive layer 3 has at least one openwork pattern 30 or at least one border pattern 31, and the hollow or border sign is printed on the top of the ink layer 2, and these signs can include a trademark, a text or a figure. In addition, a releasing layer 5 is covered on top of the printed silicone glue layer 3 to achieve the effect of protecting the screen protector, so as to prevent scratching the surface during the manufacture or delivery of the screen protector and reduce the defective rate.

With reference to FIG. 3 for a cross-sectional view of another preferred embodiment of the present invention, the screen protector further comprises a coating layer 4 which can be a colored coating film, a metal coating film, an AR, an NCVM (Non Conductive Vacuum Metallization) film, or an optical coating layer is disposed between the protective film layer 1 and the ink layer 2. During manufacture, the coating layer is coated onto the protective film layer 1 first, and then the ink layer 2 is printed, and a portion of the coating layer 4 corresponding to an external window of the ink layer 2 is removed, and an electric flat screen printing machine is used to print the printed silicone glue layer 3, and finally the releasing layer 5 and a protective layer 6 are covered thereon. When use, this screen protector structure can provide the aesthetic appearance of the screen protector with a colored coating film, a metal coating film, an AR, an NCVM film, or an optical coating layer, that can be used together with other products.

In view of the description above, the adhesive of the present invention is applied by using the electric flat screen printing machine. Compared with the prior art that attaches a purchased double-sided adhesive tape onto the substrate, the invention can reduce the material cost significantly and skip the process of cutting the double-sided adhesive tape to provide a more convenient manufacturing process. In addition, the adhesive can be distributed more uniformly through the screen printing method and fully combined with the ink of the substrate, and the ungluing problem of the prior art can be reduced and overcome.

What is claimed is:

1. A screen protector, comprising:
a protective film layer;
an ink layer, circularly disposed around full edges of the protective film layer; and
a printed adhesive layer, disposed on top of the ink layer;
wherein, the printed adhesive layer is set by a printing process.

2. The screen protector of claim 1, wherein the protective film layer is a film made of a composite material selected from the collection of, PET, PC, PP, and PMMA.

3. The screen protector of claim 1, wherein the protective film layer has a thickness falling within a range from 0.05 mm to 0.5 mm and a light transmittance falling within a range from 90% to 96%.

4. The screen protector of claim 1, further comprising a coating layer disposed between the protective film layer and the ink layer.

5. The screen protector of claim 1, wherein the printed adhesive layer includes 70% to 85% of silicone and hardening material.

6. The screen protector of claim 1, wherein the printed adhesive layer has a openwork pattern.

7. The screen protector of claim 1, wherein the printed adhesive layer has a border pattern.

8. The screen protector of claim 1, further comprising a releasing layer covered onto the printed adhesive layer.

9. The screen protector of claim 8, further comprising a protective layer covered onto the other side of the protective film layer.

10. The screen protector of claim 1, wherein the ink layer can also include luminous pigment.
